(19) United States
(12) Patent Application Publication
(10) Pub. No.: US 2010/0073754 A1
(43) Pub. Date: Mar. 25, 2010

(54) Ultraviolet light stabilizing compounds and associated media and devices

(75) Inventor: Kelvin L. Baumann, Holland, MI (US)

Correspondence Address: KING & PARTNERS, PLC;F/B/O/ GENTEX CORPORATION, 170 COLLEGE AVENUE, SUITE 230, HOLLAND, MI, 49423, US

(73) Assignee: Gentex Corporation

(21) Appl. No.: 12/284,701

(22) Filed: Sep. 24, 2008

(51) Int. Cl. G02F 1/15; C09K 9/00

(52) U.S. Cl. 359/265; 252/583

(57) ABSTRACT

An electrochromic device including a first substantially transparent substrate having an electrically conductive material associated therewith, a second substrate having an electrically conductive material associated therewith, and an electrochromic medium including at least one solvent, at least one anodic electroactive material, at least one cathodic electroactive material, wherein at least one of the anodic and cathodic electroactive materials is electrochromic, and one or more ultraviolet light stabilizing compounds including a substituted diaroyl or unsubstituted diaroyl resorcinol.

### CROSS-REFERENCE TO RELATED APPLICATION(S)

Not Applicable.

### BACKGROUND OF THE INVENTION

1. Field of the Invention

The present invention relates in general to ultraviolet (sometimes referred to herein as “UV”) light stabilizing compounds for use in solution phase electrochromic (sometimes referred to herein as “EC”) devices and, more particularly, to UV stabilizing compounds comprising substituted resorcinols (i.e. substituted 1,3-dihydroxybenzene compounds).

2. Background Art

Solution phase electrochromic devices have been known in the art for several years. See, for example, U.S. Pat. No. 4,902,108, entitled “SINGLE-COMPARTMENT, SELF-ERASING, SOLUTION-PHASE ELECTRO-CHROMIC DEVICES, SOLUTIONS FOR USE THEREIN, AND USES THEREOF,” which is hereby incorporated herein by reference in its entirety—including the references cited therein. In solution phase electrochromic devices, UV stabilizing compounds (i.e. UV stabilizers) are well known and include, for example, the compound 2-(2′-hydroxy-4′-methylphenyl)benzotriazole, sold by Ciba-Geigy Corp. under the trademark Tinuvin P, the compound 3-[3-(2H-benzotriazole-2-yl)-5-(1,1-dimethylethyl)-4-hydroxyphenyl]propionic acid pentyl ester prepared from Tinuvin 213, sold by Ciba-Geigy Corp., via conventional hydrolysis followed by conventional esterification (hereinafter “Tinuvin PE”), the material benzenepropanoic acid, 3-(2H-benzotriazol-2-yl)-5-(1,1-dimethylethyl)-4-hydroxy-, C7-9-branched and linear alkyl esters, sold by Ciba-Geigy Corp. under the trademark Tinuvin 384, the compound 2,4-dihydroxybenzophenone, sold by Aldrich Chemical Co., and the compound 2-hydroxy-4-methoxybenzophenone, sold by American Cyanamid under the trademark Cyasorb UV 9, and the compound 2-ethyl-2′-ethoxyalanilide, sold by Sandoz Color & Chemicals under the trademark Sanduvor VSU—to name a few. See also, for example, U.S. Pat. No. 6,445,486, entitled “ELECTROACTIVE MATERIALS AND BENEFICIAL AGENTS HAVING A SOLUBILIZING MOIETY,” which is hereby incorporated herein by reference in its entirety—including the references cited therein.

While the utilization of solution phase electrochromic devices which incorporate UV stabilizers into their electrochromic media has become increasing popular among, for example, the automotive industry, the development of undesirable residual color within the EC media remains problematic.

Indeed, when a sufficient electrical potential difference is applied across the electrodes of a conventional electrochromic device (e.g. an EC window, mirror, aircraft transparency, display device, etcetera), the electrochromic medium becomes intentionally colored (i.e. a low transmission state) inasmuch as one or more of the anodic and the cathodic materials are oxidized and reduced, respectively. Specifically, the anodic materials are oxidized by donating electrons to the anode and the cathodic materials are reduced by accepting electrons from the cathode.

For most commercially available devices, when the electrical potential difference is removed or substantially diminished, the anodic and cathodic materials return to their native or unactivated state and, in turn, return the electrochromic medium to its colorless or nearly colorless state (i.e. a high transmission state). The application and removal of an electrical potential difference is conventionally known as a single cycle of the electrochromic device.

Scientists have observed that over a period of cycles and/or time, during normal operation of the electrochromic device, the electrochromic medium sometimes does not remain colorless in the high transmission state. In some instances, even in the absence of an electrical potential difference, undesirable coloration of the anodic and/or cathodic compounds and/or the polymer backbone is observed—which is sometimes due, at least in part, to degradation of the same from prolonged exposure to UV light.

It is therefore an object of the present invention, among other objects, to provide UV stabilizing compounds comprising substituted resorcinols for use in the medium of an electrochromic device that minimizes the aforementioned detriments and/or complications associated with maintaining a colorless or nearly colorless electrochromic device while the device is in its high transmission state.

These and other objects of the present invention will become apparent in light of the present specification, claims, and drawings.

### SUMMARY OF THE INVENTION

The present invention is directed to an electrochromic device comprising: (a) a first substantially transparent substrate having an electrically conductive material associated therewith; (b) a second substrate having an electrically conductive material associated therewith; and (c) an electrochromic medium comprising: (1) at least one solvent; (2) at least one anodic electroactive material; (3) at least one cathodic electroactive material; (4) wherein at least one of the anodic and cathodic electroactive materials is electrochromic; and (5) an ultraviolet light stabilizing compound comprising a substituted diaroyl or unsubstituted diaroyl (e.g. benzoyl, toluoyl, etcetera) resorcinol.

The present invention is also directed to an electrochromic medium for use in an electrochromic device comprising: (a) at least one solvent; (b) at least one anodic electroactive material; (c) at least one cathodic electroactive material; (d) wherein at least one of the anodic and cathodic electroactive materials is electrochromic; and (e) an ultraviolet light stabilizing compound comprising a substituted diaroyl or unsubstituted diaroyl resorcinol.

In one embodiment of the present invention, the ultraviolet light stabilizing compound is represented by the following formula:

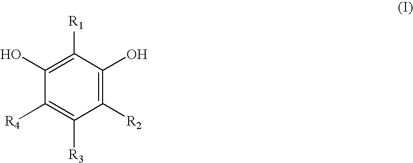

wherein R₁ -R₄ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 50 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer; with the proviso that at least two of R₁-R₄ are the same or different and comprise an aroyl group containing approximately 2 to approximately 25 carbon atom(s). In this embodiment, R1 preferably comprises H; an alkyl, alkoxy, and/or cyano group containing approximately 1 to approximately 50 carbon atom(s); a linkage to a dimer; a linkage to an oligomer; and/or a linkage to a polymer; R3 preferably comprises H; and R₂ and R₄ are the same or different and preferably comprise a substituted or unsubstituted benzoyl group containing approximately 6 to approximately 25 carbon atoms.

In another embodiment of the present invention, the ultraviolet light stabilizing compound is represented by the following formula:

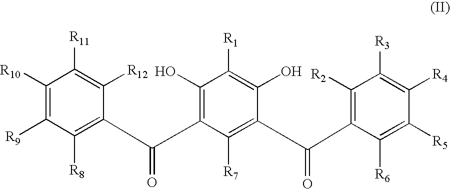

wherein R₁-R₁₂ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer.

In yet another embodiment of the present invention, the ultraviolet light stabilizing compound is represented by the following formula:

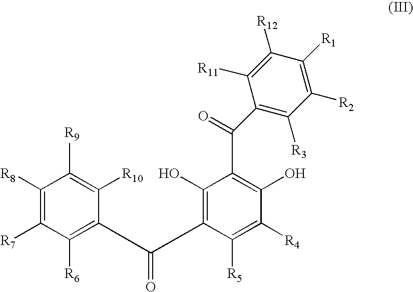

wherein R₁-R₁₂ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer.

In another aspect of the present invention, the ultraviolet light stabilizing compound is represented by the following formula:

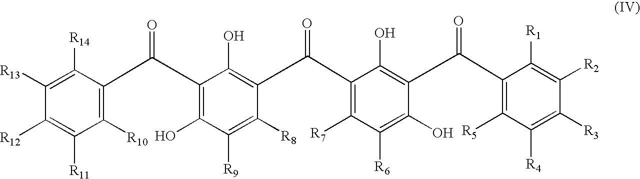

wherein R₁-R₁₄ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer.

In one embodiment of the present invention, the ultraviolet light stabilizing compound is represented by the following formula:

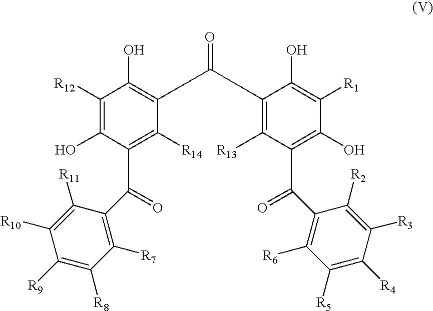

wherein R₁-R₁₄ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer.

In another embodiment of the present invention, the ultraviolet light stabilizing compound is represented by the following formula:

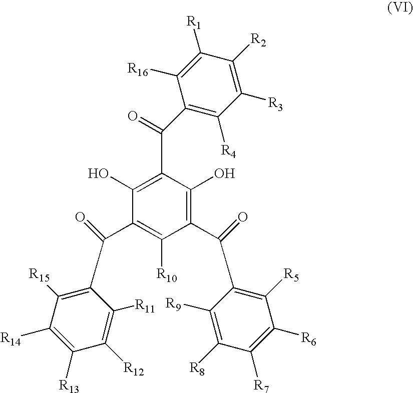

wherein R₁-R₁₆ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer.

In yet another preferred embodiment of the present invention, the EC medium further comprises at least one of a cross-linked polymer matrix, a free-standing gel, and a substantially non-weeping gel.

In accordance with the present invention, the electrochromic device may comprise an aircraft transparency, a window, a mirror, etcetera, and may include a perimeter metallic ring, as well as a self-cleaning, hydrophilic coating.

These and other features, advantages, and objects of the present invention will be further understood and appreciated by those skilled in the art by reference to the following specification, claims, and appended drawings.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be further understood that the invention is not necessarily limited to the particular embodiments illustrated herein.

The invention will now be described with reference to the drawings wherein:

FIG. 1 of the drawings is a cross-sectional schematic representation of an electrochromic device fabricated in accordance with the present invention;

FIG. 2 of the drawings is a two-dimensional plot showing color change (ΔE) as a function of exposure time to UV light for Experiments 1A-1C (static); and

FIG. 3 of the drawings is a two-dimensional plot showing color change (ΔE) as a function of exposure time to UV light for Experiments 2A-2C (cycling).

### DETAILED DESCRIPTION OF THE INVENTION

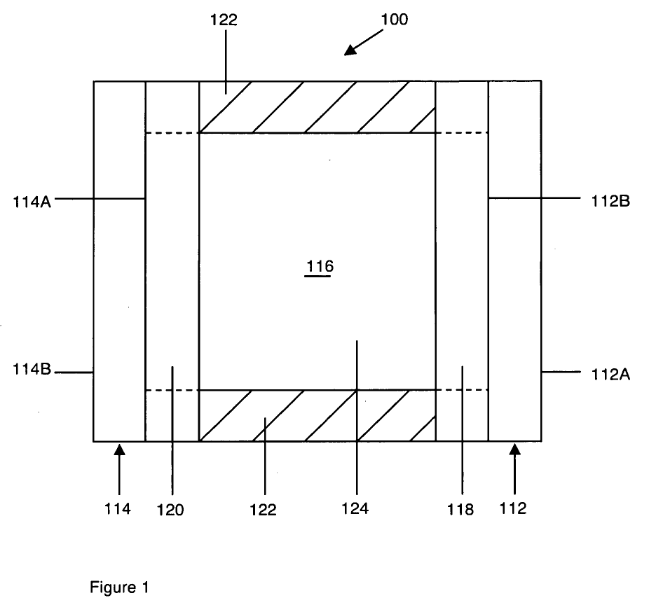

Referring now to the drawings and to FIG. 1 in particular, a cross-sectional schematic representation of electrochromic device 100 is shown, which generally comprises first transparent substrate 112 having front surface 112A and rear surface 112B, second substrate 114 having front surface 114A and rear surface 114B, which may also be transparent, first transparent electrode (i.e. electrically conductive material) 118 associated with rear, inward-facing surface 112B of first transparent substrate 112, second electrode (i.e. electrically conductive material) 120, which may also be transparent, associated with front, inward-facing surface 114A of second substrate 114, and seal 122 provided between the two layered substrates. Substrates 112 and 114 are preferably maintained in a generally parallel, spaced-apart manner. Seal 122 serves to provide chamber 116 between substrates 112 and 114 in which electrochromic medium 124 is contained in contact with both electrodes 118 and 120.

It will be understood that electrochromic device 100 may comprise, for illustrative purposes only, an aircraft transparency, a window, a mirror, a display device, and the like. It will be further understood that FIG. 1 is merely a schematic representation of electrochromic device 100. As such, some of the components have been distorted from their actual scale for pictorial clarity. Indeed, numerous other electrochromic device configurations are contemplated for use, including those disclosed in U.S. Pat. No. 5,818,625, entitled “ELECTROCHROMIC REARVIEW MIRROR INCORPORATING A THIRD SURFACE METAL REFLECTOR,” and U.S. Pat. No. 6,597,489, entitled “ELECTRODE DESIGN FOR ELECTROCHROMIC DEVICES,” both of which are hereby incorporated herein by reference in their entirety.

In accordance with the present invention, electrochromic medium 124 preferably comprises at least one solvent, at least one anodic material, and at least one cathodic material. Typically both of the anodic and cathodic materials are electroactive and at least one of them is electrochromic. It will be understood that regardless of its ordinary meaning, the term “electroactive” will be defined herein as a material that undergoes a modification in its oxidation state upon exposure to a particular electrical potential difference. Additionally, it will be understood that the term “electrochromic” will be defined herein, regardless of its ordinary meaning, as a material that exhibits a change in its extinction coefficient at one or more wavelengths upon exposure to a particular electrical potential difference.

Electrochromic medium 124 is preferably chosen from one of the following categories:

Single layer—the electrochromic medium is a single layer of material, which may include small inhomogeneous regions and includes solution-phase devices where a material is contained in solution in the ionically conducting electrolyte and remains in solution in the electrolyte when electrochemically oxidized or reduced. U.S. Pat. No. 6,193,912, entitled “NEAR INFRARED-ABSORBING ELECTROCHROMIC COMPOUNDS AND DEVICES COMPRISING SAME,” U.S. Pat. No. 6,188,505, entitled “COLOR-STABILIZED ELECTROCHROMIC DEVICES,” U.S. Pat. No. 6,262,832, entitled “ANODIC ELECTROCHROMIC MATERIALS HAVING A SOLUBILIZING MOIETY,” U.S. Pat. No. 6,137,620, entitled “ELECTROCHROMIC MEDIA WITH CONCENTRATION-ENHANCED STABILITY, PROCESS FOR THE PREPARATION THEREOF AND USE IN ELECTROCHROMIC DEVICES,” U.S. Pat. No. 6,195,192, entitled “ELECTROCHROMIC MATERIALS WITH ENHANCED ULTRAVIOLET STABILITY,” U.S. Pat. No. 6,392,783, entitled “SUBSTITUTED METALLOCENES FOR USE AS ANODIC ELECTROCHROMIC MATERIALS, AND ELECTROCHROMIC MEDIA AND DEVICES COMPRISING THE SAME,” and U.S. Pat. No. 6,249,369, entitled “COUPLED ELECTROCHROMIC COMPOUNDS WITH PHOTOSTABLE DICATION OXIDATION STATES” disclose anodic and cathodic materials as well as numerous solvents that may be used in a single layer electrochromic medium, the disclosures of which are hereby incorporated herein by reference in their entirety—including the references cited therein. Solution-phase electroactive materials may be contained in the continuous solution phase of a cross-linked polymer matrix in accordance with the teachings of U.S. Pat. No. 5,928,572, entitled “ELECTROCHROMIC LAYER AND DEVICES COMPRISING SAME” or International Patent Application No. PCT/US98/05570, entitled “ELECTROCHROMIC POLYMERIC SOLID FILMS, MANUFACTURING ELECTROCHROMIC DEVICES USING SUCH SOLID FILMS, AND PROCESSES FOR MAKING SUCH SOLID FILMS AND DEVICES,” the disclosures of which are hereby incorporated herein by reference in their entirety—including the references cited therein.

At least three electroactive materials, at least two of which are electrochromic, can be combined to give a pre-selected color as described in U.S. Pat. No. 6,020,987, entitled “ELECTROCHROMIC MEDIUM CAPABLE OF PRODUCING A PRE-SELECTED COLOR,” the entire disclosure of which is incorporated herein by reference. This ability to select the color of the electrochromic medium is particularly advantageous when designing architectural windows.

The anodic and cathodic materials can be combined or linked by a bridging unit as described in International Patent Application No. PCT/WO97/EP498, entitled “ELECTROCHROMIC SYSTEM,” the entire disclosure of which is hereby incorporated herein by reference. It is also possible to link anodic materials or cathodic materials by similar methods. The concepts described in these applications can further be combined to yield a variety of electrochromic materials that are linked.

Additionally, a single layer medium includes the medium where the anodic and cathodic materials can be incorporated into the polymer matrix as is described in International Patent Application No. PCT/WO98/EP3862, entitled “ELECTROCHROMIC POLYMER SYSTEM,” U.S. Pat. No. 6,002,511, or International Patent Application No. PCT/US98/05570, entitled “ELECTROCHROMIC POLYMERIC SOLID FILMS, MANUFACTURING ELECTROCHROMIC DEVICES USING SUCH SOLID FILMS, AND PROCESSES FOR MAKING SUCH SOLID FILMS AND DEVICES,” the disclosures of which are hereby incorporated herein by reference in their entirety—including the references cited therein.

Also included is a medium where one or more materials in the medium undergoes a change in phase during the operation of the device, for example, a deposition system where a material contained in solution in the ionically-conducting electrolyte which forms a layer or partial layer on the electrically conducting electrode when electrochemically oxidized or reduced.

Multilayer—the medium is made up in layers and includes at least one material attached directly to an electrically conducting electrode or confined in close proximity thereto which remains attached or confined when electrochemically oxidized or reduced. Examples of this type of electrochromic medium are the metal oxide films, such as tungsten oxide, iridium oxide, nickel oxide, and vanadium oxide. A medium, which contains one or more organic electrochromic layers, such as polythiophene, polyaniline, or polypyrrole attached to the electrode, are also considered a multilayer medium.

It may be desirable to incorporate one or more of a cross-linked polymer matrix, a free-standing gel, and a substantially non-weeping gel into the electrochromic device as is disclosed in U.S. Pat. No. 5,940,201 entitled “ELECTROCHROMIC MIRROR WITH TWO THIN GLASS ELEMENTS AND A GELLED ELECTROCHROMIC MEDIUM,” the entire disclosure of which is hereby incorporated herein by reference.

In addition, the electrochromic medium may comprise other materials, such as light absorbers, conventional light (UV) stabilizers, thermal stabilizers, antioxidants, thickeners, viscosity modifiers, tint providing agents, redox buffers also referred to as color-stabilizing additives, and mixtures thereof. Conventional UV-stabilizers may include: the compound 2-ethyl-2-cyano-3,3-diphenyl acrylate, sold by BASF of Parsippany, N.Y., under the trademark Uvinul N-35, and by Aceto Corp., of Flushing, N.Y., under the trademark Viosorb 910; the compound (2-ethylhexyl)-2-cyano-3,3-diphenyl acrylate, sold by BASF under the trademark Uvinul N-539; the material 2-(2′-hydroxy-4′-methylphenyl)benzotriazole, sold by Ciba-Geigy Corp. under the trademark Tinuvin P; the material 3-[3-(2H-benzotriazole-2-yl)-5-(1,1-dimethylethyl)-4-hydroxyphenyl]propionic acid pentyl ester prepared from Tinuvin 213, sold by Ciba-Geigy Corp., via conventional hydrolysis followed by conventional esterification (hereinafter “Tinuvin PE”); the material benzenepropanoic acid, 3-(2H-benzotriazol-2-yl)-5-(1,1-dimethylethyl)-4-hydroxy-, C7-9-branched and linear alkyl esters, sold by Ciba-Geigy Corp. under the trademark Tinuvin 384; the compound 2,4-dihydroxybenzophenone, sold by, among many others, Aldrich Chemical Co.; the compound 2-hydroxy-4-methoxybenzophenone sold by American Cyanamid under the trademark Cyasorb UV 9; and the compound 2-ethyl-2′-ethoxyalanilide, sold by Sandoz Color & Chemicals under the trademark Sanduvor VSU—to name a few. As will be discussed infra UV stabilizers of the present invention comprise one or more substituted resorcinols.

For illustrative purposes only, the concentration of the anodic and cathodic materials can range from approximately 1 millimolar (mM) to approximately 500 mM and more preferably from approximately 2 mM to approximately 100 mM. While particular concentrations of the anodic as well as cathodic materials have been provided, it will be understood that the desired concentration may vary greatly depending upon the geometric configuration of the chamber containing electrochromic medium 124.

For purposes of the present disclosure, a solvent of electrochromic medium 124 may comprise any one of a number of common, commercially available solvents including 3-methylsulfolane, dimethyl sulfoxide, dimethyl formamide, tetraglyme, and other polyethers; alcohols such as ethoxyethanol; nitriles, such as acetonitrile, glutaronitrile, 3-hydroxypropionitrile, and 2-methylglutaronitrile; ketones including 2-acetylbutyrolactone, and cyclopentanone; cyclic esters including beta-propiolactone, gamma-butyrolactone, and gamma-valerolactone; cyclic carbonates including propylene carbonate (PC), ethylene carbonate; and homogenous mixtures of the same. While specific solvents have been disclosed as being associated with the electrochromic medium, numerous other solvents that would be known to those having ordinary skill in the art having the present disclosure before them are likewise contemplated for use.

Transparent substrate 112 may be fabricated from any material that is transparent and has sufficient strength to be able to operate in the environmental conditions to which the device will be exposed. Substrate 112 may comprise any type of borosilicate glass, soda lime glass, float glass, or any one of a number of other materials, such as, for example, MYLAR®, polyvinylidene chloride, polyvinylidene halides, such as polyvinylidene fluoride, a polymer or plastic, such as cyclic olefin copolymers like Topas® available from Ticona, LLC of Summitt, N.J., that is transparent in the visible region of the electromagnetic spectrum. While particular substrate materials have been disclosed, for illustrative purposes only, it will be understood that numerous other substrate materials are likewise contemplated for use—so long as the materials are at least substantially transparent and exhibit appropriate physical properties, such as strength, to be able to operate effectively in conditions of intended use. Indeed, electrochromic devices in accordance with the present invention can be, during normal operation, exposed to extreme temperature variation, as well as substantial UV radiation, emanating primarily from the sun.

Second substrate 114 will also have sufficient strength and be able to operate in the environmental conditions to which the device will be exposed. For use as an EC window, substrate 114 will also be transparent and preferably made from the same material as substrate 112. If the device is to be used as a mirror or other device that does not require light to pass through the entire device, substrate 114 may comprise a ceramic or metallic material. It will be understood that first and/or second substrates 112 and 114, respectively, can optionally be tempered, heat strengthened, and/or chemically strengthened, prior to or subsequent to being coated with layers of electrically conductive material (118 and 120). First substrate 112 and second substrate 114 are preferably fabricated from a sheet of glass having a thickness ranging from approximately 0.5 millimeters (mm) to approximately 12.7 mm, and more preferably less than approximately 1.0 mm for certain low weight applications.

Additionally, substrates 112 and 114 may be treated or coated as is described in U.S. Pat. No. 6,239,898, entitled “ELECTROCHROMIC STRUCTURES,” U.S. Pat. No. 6,193,378, entitled “ELECTROCHROMIC DEVICE HAVING A SELF-CLEANING HYDROPHILIC COATING,” and U.S. Pat. No. 6,816,297, entitled “ELECTROCHROMIC MIRROR HAVING A SELF-CLEANING HYDROPHILIC COATING,” the disclosures of which are hereby incorporated herein by reference in their entirety. Other treatments, such as anti-reflectance coatings, hydrophilic coatings, low-E coatings, and UV-blocking layers are also contemplated for use in accordance with the present invention. It will be understood that such coatings may be associated with substrates 112 and/or 114 in this as well as other embodiments.

Transparent electrode 118 may be made of any material which bonds well to transparent substrate 112, is resistant to corrosion to any materials within the electrochromic device, is resistant to corrosion by the atmosphere, has minimal diffuse or specular reflectance, high light transmission, near neutral coloration, and good electrical conductance. Transparent electrode 118 comprises, for example, fluorine-doped tin oxide, doped zinc oxide, zinc-doped indium oxide, tin-doped indium oxide (ITO), ITO/metal/ITO (IMI) as is disclosed in “Transparent Conductive Multilayer-Systems for FPD Applications,” by J. Stollenwerk, B. Ocker, K. H. Kretschmer of LEYBOLD AG, Alzenau, Germany, the materials described in above-referenced U.S. Pat. No. 5,202,787, such as TEC 20 or TEC 15, available from Libbey Owens-Ford Co. of Toledo, Ohio, or other transparent conductors. Generally, the conductance of transparent electrode 118 will depend on its thickness and composition. IMI generally has superior conductivity compared with the other materials. The thickness of the various layers in the IMI structure may vary, but generally the thickness of the first ITO layer ranges from about 10 Å to about 200 Å, the metal ranges from about 10 Å to about 200 Å, and the second layer of ITO ranges from about 10 Å to about 200 Å. If desired, an optional layer or layers of a color suppression material may be deposited between transparent electrode 118 and inner surface 112B of substrate 112 to suppress the transmission of any unwanted portions of the electromagnetic spectrum. Electrode 120 may comprise many of the same properties as transparent electrode 118, and can be fabricated from the same materials; however, if electrode 120 is not required to be transparent it may be made of metals such as silver, gold, platinum, and alloys thereof.

In the particular embodiment shown in FIG. 1, seal 122 may be any material that is capable of adhesively bonding to the inner surfaces of elements 112 and 114 and/or electrodes 118 and 120, to seal the perimeter, such that electrochromic medium 124 does not leak from the chamber defined between the transparent substrates. The seal preferably has good adhesion to glass, metals, metal oxides, and other substrate materials; preferably has low permeabilities for oxygen, moisture vapor, and other detrimental vapors and gasses; and must not interact with or poison the electrochromic material it is meant to contain and protect. The seal may be applied in any conventional manner. A preferred seal material and method for applying the seal as well as a preferred method of constructing electrochromic device 100 are described further below.

Electrochromic device 100 further includes a means of providing electrical contact to the electrochromic medium, such as bus clips (not shown) that can be clipped about the perimeter of first and second elements 112 and 114 in such a manner as to physically and electrically contact electrodes 118 and 120 as is disclosed in U.S. Pat. No. 6,407,847, entitled “ELECTROCHROMIC MEDIUM HAVING A COLOR STABILITY,” which is hereby incorporated herein by reference in its entirety. Bus clips thus enable electrical current to flow between an external driving circuit through first and second electrodes 118 and 120 and electrochromic medium 124 contained in chamber 116 therebetween. In this manner, the light transmittance of electrochromic device 100 may be varied in response to the electrical control of an external drive circuit. It will be understood that bus clips may be made of any known construction and/or known materials. One possible construction for bus clips is disclosed in U.S. Pat. No. 6,064,509, entitled “CLIP FOR USE WITH TRANSPARENT CONDUCTIVE ELECTRODES IN ELECTROCHROMIC DEVICES,” the disclosure of which is hereby incorporated herein by reference in its entirety. Additionally, electrical contact may be provided by conventional conductive inks, metal foils, and the like, such as are used in electrochromic mirrors with a metallic ring that is visible around the perimeter of the mirror as is disclosed in U.S. Application Ser. No. 60/614,150, entitled “VEHICULAR REARVIEW MIRROR ELEMENTS AND ASSEMBLIES INCORPORATING THESE ELEMENTS,” which is hereby incorporated herein by reference in its entirety.

Referring once again to EC medium 124, anodic materials suitable for use in accordance with the present invention may comprise any one of a number of materials including ferrocene, substituted ferrocenes, substituted ferrocenyl salts, substituted phenazines, phenothiazine, substituted phenothiazines, thianthrene, and substituted thianthrenes. Examples of anodic materials may include di-tert-butyl-diethylferrocene, 5,10-dimethyl-5,10-dihydrophenazine, 3,7,10-trimethylphenothiazine, 2,3,7,8-tetramethoxythianthrene, and 10-methylphenothiazine. It is also contemplated that the anodic material may comprise a polymer film, such as polyaniline, polythiophenes, polymeric metallocenes, or a solid transition metal oxide, including, but not limited to, oxides of vanadium, nickel, iridium, as well as numerous heterocyclic compounds, etcetera. It will be understood that numerous other anodic materials are contemplated for use including those disclosed in U.S. Pat. No. 4,902,108, entitled “SINGLE-COMPARTMENT, SELF-ERASING, SOLUTION-PHASE ELECTROCHROMIC DEVICES, SOLUTIONS FOR USE THEREIN, AND USES THEREOF,” U.S. Pat. No. 7,428,091, entitled “ELECTROCHROMIC COMPOUNDS AND ASSOCIATED MEDIA AND DEVICES,” as well as U.S. Pat. No. 6,188,505, entitled “COLOR-STABILIZED ELECTROCHROMIC DEVICES,” all of which are hereby incorporated herein by reference in their entirety—including the references cited therein.

Suitable cathodic materials may include, for example, viologens, such as methyl viologen tetrafluoroborate, octyl viologen tetrafluoroborate, or benzyl viologen tetrafluoroborate. It will be understood that the preparation and/or commercial availability for each of the above-identified cathodic materials is well known in the art. See, for example, “The Bipyridinium Herbicides” by L. A. Summers (Academic Press 1980). While specific cathodic materials have been provided for illustrative purposes only, numerous other conventional cathodic materials are likewise contemplated for use including, but by no means limited to, those disclosed in U.S. Pat. No. 4,902,108, entitled “SINGLE-COMPARTMENT, SELF-ERASING, SOLUTION-PHASE ELECTROCHROMIC DEVICES, SOLUTIONS FOR USE THEREIN, AND USES THEREOF,” U.S. patent application Ser. No. 12/229,606, entitled “ELECTROCHROMIC COMPOUNDS AND ASSOCIATED MEDIA AND DEVICES,” and U.S. Pat. No. 6,710,906, entitled “CONTROLLED DIFFUSION COEFFICIENT ELECTROCHROMIC MATERIALS FOR USE IN ELECTROCHROMIC MEDIUMS AND ASSOCIATED ELECTROCHROMIC DEVICES,” all of which are hereby incorporated herein by reference in their entirety—including the references cited therein.

As was briefly discussed supra, the present invention is directed to UV stabilizing compounds comprising substituted diaroyl or unsubstituted diaroyl (e.g. benzoyl, toluoyl, etcetera) resorcinols for use in the medium of an electrochromic device. Indeed, as will be shown experimentally below, it has been surprisingly discovered that the substituted diaroyl or unsubstituted diaroyl resorcinols of the present invention facilitate maintaining a colorless or nearly colorless electrochromic device while the device is in its high transmission state.

In accordance with the present invention, suitable ultraviolet light stabilizing compounds (i.e. substituted diaroyl or unsubstituted diaroyl resorcinols) include, but are not limited to, those represented by formulae I-VI provided herein below.

In one embodiment of the present invention, the ultraviolet light stabilizing compounds are represented by the following formula:

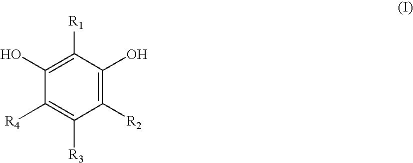

wherein R₁-R₄ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 50 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer; with the proviso that at least two of R₁-R₄ are the same or different and comprise an aroyl (e.g. benzoyl, toluoyl, etcetera) group containing approximately 2 to approximately 25 carbon atom(s).

Preferably, R1 comprises H; an alkyl, alkoxy, and/or cyano group containing approximately 1 to approximately 50 carbon atom(s); a linkage to a dimer; a linkage to an oligomer; and/or a linkage to a polymer; R3 comprises H; and R₂ and R₄ are the same or different and comprise a substituted or unsubstituted benzoyl group containing approximately 6 to approximately 25 carbon atoms.

In another aspect of the present invention, the ultraviolet light stabilizing compounds are represented by the following formula:

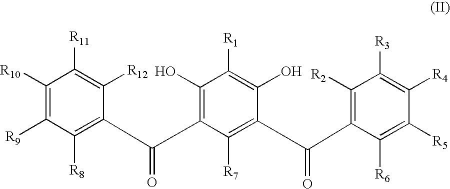

wherein R₁-R₁₂ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer.

In yet another embodiment of the present invention, the ultraviolet light stabilizing compounds are represented by the following formula:

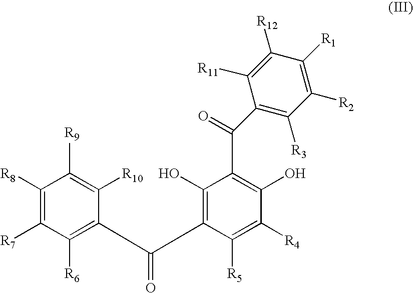

wherein R₁-R₁₂ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer.

In a fourth embodiment of the present invention, the ultraviolet light stabilizing compounds are represented by the following formula:

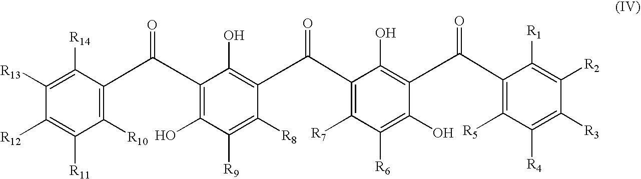

wherein R₁-R₁₄ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer.

In a fifth embodiment of the present invention, the ultraviolet light stabilizing compounds are represented by the following formula:

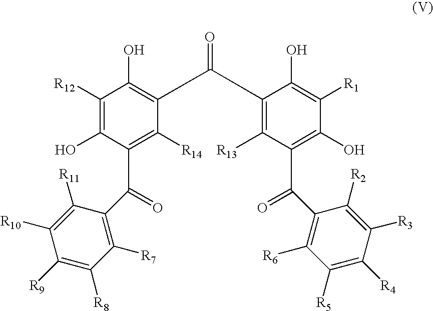

wherein R₁-R₁₄ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer.

In a sixth embodiment of the present invention, the ultraviolet light stabilizing compounds are represented by the following formula:

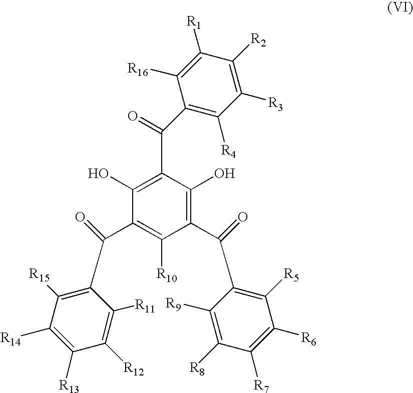

wherein R₁-R₁₆ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer.

Electrochromic devices having as a component part an electrochromic medium as defined herein can be used in a wide variety of applications wherein the transmitted or reflected light can be modulated. Such devices include rear-view mirrors for vehicles; windows for the exterior of a building, home, or vehicle including aircraft transparencies; skylights for buildings including tubular light filters; windows in office or room partitions; display devices; aerospace windows; contrast enhancement filters for displays; and light filters for photographic devices and light sensors—just to name a few.

It will be understood that, unless otherwise specified, the chemical reagents and compounds provided herein below, or their precursors, are available from common commercial chemical vendors, such as Aldrich Chemical Co., of Milwaukee, Wis.

The invention is further described by the following examples.

### EXAMPLE 1

### Preparation of 4,6-dibenzoyl resorcinol

A one liter (L) 3-neck round-bottom flask fitted with a reflux condenser and magnetic stirrer under positive nitrogen pressure was charged with 400 milliliters (ml) of 1,2 dichloroethane and 59.0 grams (g) of benzoyl chloride. The mixture was agitated and charged with 58.7 g of 99% aluminum chloride powder. The resulting slurry was stirred for two hours (h) and an exotherm of 35 degrees Centigrade (° C.) was observed. With a liquid addition funnel, 27.6 g of 1,3-dimethoxy benzene was charged over two h. This mixture exothermed to 45° C., before cooling to room temperature gradually. This was stirred over 16 h at room temperature to form the Friedel-Crafts product of 4,6-dibenzoyl-1,3-dimethoxy benzene.

The mixture was then heated to reflux for 2 h, cooled to 30° C., and then the reaction was quenched with slow addition of 400 ml of 2 N aqueous hydrochloric acid. This process allowed for the deprotection of the methyl ethers to form hydroxyl groups and the desired product when quenched with water. The acid-treated reaction solution was transferred to a separatory funnel and the lower organic layer was collected which contained desired product and the top acid layer was discarded. In a similar fashion, in the separatory funnel, the organic layer was then washed with 400 ml of 1 N aqueous hydrochloric acid and then three times with 200 ml of reverse osmosis purified water. The resulting dichloroethane solution was concentrated to 100 ml total volume and cooled to 5° C. overnight. Light orange-colored crystals were collected with a vacuum filtration apparatus and were washed with 50 ml of cold methanol. This yielded 36.2 g of 4,6-dibenzoyl resorcinol which was further purified with recrystallization. The crystalline product was dissolved in 75 ml of acetone and 75 ml of ethanol. 75 ml of the solution was removed with atmospheric distillation and resulting slurry was cooled to room temperature overnight. The purified product was filtered with a vacuum filtration apparatus and washed with 50 ml of cold ethanol. It was then dried under vacuum at 50° C. to yield 27.9 g of almost white 4,6-dibenzoyl resorcinol.

### EXAMPLE 2

### Preparation of 4,6-di(para-toluoyl)resorcinol

A one L 3-neck round-bottom flask was set-up with a magnetic stirrer, nitrogen purge, and reflux condenser. 400 ml of 1,2 dichloroethane and 64.5 g of para-toluoyl chloride were charged to the reaction flask. Next 56.3 g of 99% aluminum chloride powder charged to the reaction flask which caused an exotherm to 40° C. The reaction mixture was stirred for 2 h as it cooled to 30° C. With a liquid addition funnel, 27.6 g of 1,3-dimethoxy benzene, was charged over 20 minutes. The resulting reaction mixture exothermed to 43° C. and evolved HCl gas. This reaction mixture was stirred overnight at room temperature to allow the Friedel-Crafts acylation to go to completion.

The 4,6-di(para-toluoyl)1,3-dimethoxy benzene had formed and now the reaction mixture was heated to 70° C. over 4 h. The mixture was then cooled to 35° C. and 400 ml of 2 N aqueous hydrochloric acid was added over 2 h. The reaction mixture formed an exotherm which heated the mixture to 75° C. Heating of the reaction mixture and quenching with dilute acid served to deprotect the methyl ether groups and formed the desired product. The resulting 2-phase reaction solution was transferred to a separation funnel and the lower organic layer, containing product, was collected. The top layer, acid wash, was discarded. In a similar fashion the 1,2-dichloroethane layer, containing product, was then washed with 400 ml of 1 N aqueous hydrochloric acid and then twice washed with 400 ml of reverse osmosis purified water. The dichloroethane was then concentrated to about 100 ml of total volume with a vacuum distillation as crystallization began. To this slurry, was added 100 ml of hexane and then was cooled to 5° C. overnight. Crystalline 4,6-di(para-toluoyl)resorcinol was collected with a vacuum filtration and was washed with 50 ml of hexanes. This yielded 40.5 g of a yellow crystalline product. The product was then purified further by dissolving in 150 ml of acetone and 150 ml of ethanol at 60° C. 200 ml of solvent was removed with atmospheric distillation then the resulting crystallization slurry was cooled to room temperature and finally to 5° C. for 2 h. Recrystallized product was collected with vacuum filtration and was washed with 50 ml of cold methanol. Product was then dried under vacuum at 50° C. for 8 h. Overall yield of pure 4,6-di(para-toluoyl)resorcinol was 36.2 g or 52.3%.

### EXAMPLE 3

### Preparation of 4,6-di(meta-toluoyl)resorcinol

A one L 3-neck round-bottom flask was prepared by attaching a water-cooled reflux condenser, a magnetic stirrer and a nitrogen purge. The reaction vessel was charged with 400 ml of 1,2-dichloroethane and 56.3 g of 99% aluminum chloride powder. This mixture was stirred for 15 minutes and then 64.5 g of meta-toluoyl chloride was slowly added. The reaction slurry eventually dissolved and exothermed to 35° C. After stirring for 2 h the reaction solution had cooled to 30° C. At this point, 27.6 g of 1,3 dimethoxy benzene was added evenly over 20 minutes. During addition, effervescence caused by evolving HCl gas was observed and the solution exothermed to 43° C. This solution was allowed to stir overnight to accomplish a completion of the Friedel-Crafts acylation and formation of 4,6-di(meta-toluoyl)resorcinol.

The next day, the reaction was heated for 3 h at 70° C. which was sampled for determination of reaction completion. The reaction was not yet complete and after cooling to 40° C. an additional 10 g of 99% aluminum chloride powder was charged to the reaction vessel. The reaction mixture was heated to 70° C. for another 2 h. After cooling to 30° C., 400 ml of 2 N aqueous hydrochloric acid was added over 15 minutes. The deprotection of the methyl ether groups was complete and the resulting 2-phase reaction solution was transferred to a separatory funnel. The lower organic layer, containing desired product, was collected and the upper layer containing the aluminum salts was discarded. In a similar fashion the organic layer was washed in the separatory funnel with 400 ml of 1 N aqueous hydrochloric acid and then twice with 400 ml of reverse osmosis purified water. The organic layer was concentrated to an oil with a vacuum distillation. The resulting oil was dissolved into 200 ml of acetone and 200 ml of ethanol at 60° C. Then 200 ml of solvent was distilled off with an atmospheric distillation. The resulting crystallization solution was cooled to 5° C. for 2 h. Product was then collected with a vacuum distillation and was washed with 50 ml of cold methanol. This yielded 35.6 g of nearly white 4,6-di(meta-toluoyl)1,3-dimethoxybenzene.

### EXAMPLE 4

### Preparation of 4,6-dibenzoyl-2-methyl resorcinol

A 500 ml 1-neck round bottom flask was fitted with a magnetic stirrer, a water-cooled reflux condenser and a nitrogen purge, which was charged with 150 ml of toluene and 24.8 g of 2-methyl resorcinol. 60.6 g of triethylamine was added to the stirred solution. Finally 70.3 g of benzoyl chloride was dripped into the reaction solution over 2 h. The reaction mixture was stirred at room temperature for 1 h and then heated to reflux overnight to allow for the complete formation of the 1,3-dibenzoate-2-methyl benzene.

The next day the reaction mixture was cooled to room temperature and charged with 50 ml of water. The 2-phase solution was transferred to a separatory funnel and the lower aqueous layer was discarded. The toluene solution was washed again with 100 ml of water. The washed toluene layer was concentrated to an oil and 100 ml of hexane was added. The resulting crystallization slurry was cooled to 5° C. for 2 h, after which the white crystalline dibenzoate ester was filtered off and washed with 50 ml of hexane. After air-drying, 55.2 g of the di-ester remained.

16.6 g of the pure di-ester was charged to a 1 L 3-neck round-bottom flask to undergo a Fries Rearrangement with trifluoromethane sulfonic acid. With a nitrogen purge on the flask, an attached water-cooled reflux condenser and a magnetic stirrer, the flask was prepared for the following reaction. To the di-ester in the flask was added 250 ml of 1,2-dichloroethane as solvent and 30 g of trifluoromethane sulfonic acid. The resulting solution was stirred overnight at room temperature to allow for completion of the Fries Rearrangement reaction.

The next day 100 ml of water was slowly added to the reaction flask to quench the reaction. The 2-phase reaction mixture was transferred to a separatory funnel and the lower aqueous layer was discarded. The upper organic layer, containing the desired 4,6-dibenzoyl-2-methyl resorcinol, was washed again with 100 ml of water. The toluene layer was concentrated with a vacuum distillation to a light orange-colored solid. This solid was dissolved into 400 ml of 50° C. acetone. 300 ml of the acetone was atmospherically distilled off and the resulting solution cooled at 5° C. overnight to crystallize.

The next day desired product was captured with a vacuum filtration which was washed with 50 ml of cold methanol. The crystal was purified further, by dissolving in 400 ml of 50° C. acetone. 300 ml of acetone was atmospherically distilled away and the resulting solution cooled at 0° C. for 2 h to crystallize. Another vacuum filtration and wash with cold methanol left 14.6 g of pure 4,6-dibenzoyl-2-methyl resorcinol.

### EXAMPLE 5

### Preparation of 4,6-di(para-toluoyl)-2-methyl resorcinol

4,6-di(para-toluoyl)resorcinol was prepared in a 1-pot, 2-step reaction which involved esterification, followed by a Fries Rearrangement. A 500 ml 3-neck round-bottom flask that was fitted with a nitrogen purge, water-cooled reflux condenser and magnetic stirrer was charged with 200 ml of 1,2 dichlorobenzene and 12.4 g of 2-methyl resorcinol. This was stirred until the resorcinol dissolved, and then 26.8 g of 99% aluminum chloride powder was added. This slurry was stirred for 15 minutes and then with a liquid addition funnel, 34.0 g of para-toluoyl chloride was charged evenly over 15 minutes. This esterfication reaction was stirred for 2 h at room temperature after which the 1,3-di(para-toluonate)-2-methyl resorcinol had completely formed.

The reaction solution was heated to 150° C. and held at that temperature for 1 h until the Fries Rearrangement was complete. After cooling to 30° C., 200 ml of 2 N aqueous hydrochloric acid was added slowly, and then the 2-phase reaction solution was heated to 80° C. The reaction solution was then transferred to a separatory funnel. The lower organic layer containing desired product was isolated and the upper acid wash, containing the aluminum salts was discarded. The organic layer was re-introduced to the separatory funnel and washed with 200 ml of 1 N aqueous hydrochloric acid and then twice washed with 200 ml of reverse osmosis purified water.

300 ml of hexane was added to the dichlorobenzene solution which contained the desired product. The crystallization solution was cooled to 0° C. and maintained overnight. The next day crystalline 4,6-di(para-toluoyl)-2-methyl resorcinol was collected by vacuum filtration which was washed with 50 ml of hexanes. The light orange-colored crystals were air-dried to 23.8 g.

To further purify, the crystals were dissolved into 100 ml of acetone and 100 ml of ethanol at 60° C. 100 ml of solvent was then removed with an atmospheric distillation and the resulting solution was cooled to 5° C. overnight. The next day pure 4,6-di(para-toluoyl)-2-methyl resorcinol was filtered off with a vacuum filtration and washed with 50 ml of cold methanol. The light tan-colored crystals were dried under vacuum at 50° C. for 4 h.

### EXAMPLE 6

### Preparation of 4,6-di(meta-toluoyl)-2-methyl resorcinol

A 500 ml 3-neck round-bottom flask was fitted with a water-cooled reflux condenser, a nitrogen purge and a magnetic stirrer and charged with 200 ml of 1,2 dichloroethane, 12.4 g of 2-methyl resorcinol and 29.5 g of 99% aluminum chloride powder. The reaction mixture was stirred for 15 minutes and then 34.0 g of meta-toluoyl chloride was added over 1 h using a liquid addition funnel. This esterification reaction was stirred for 1 h at room temperature and then 1 h at reflux, until the reaction was complete and the 1,3-di(meta-toluonate)-2-methyl benzene formed.

The reaction mixture was cooled to 50° C. and then 220 ml of 2 N aqueous hydrochloric acid was added over 15 minutes. The 2-phase reaction solution was then transferred to a separatory funnel and the lower organic layer containing the di-ester was collected. The upper layer containing the aluminum salts was discarded. The organic layer was then washed in a similar fashion in the separatory funnel with 200 ml of 1 N aqueous hydrochloric acid and then washed 3 times with 200 ml of water. The organic layer was concentrated to an oil with vacuum distillation to which was added 60 ml of 50° C. methanol for crystallization. After 2 h at 5° C. the di-ester product was filtered with vacuum filtration, washed with cold methanol and air-dried to 29.5 g.

22.6 g of the di-ester was charged to a 500 ml 3-neck round-bottom flask that was fitted with a nitrogen purge, a reflux condenser and a magnetic stirrer. The di-ester was dissolved into 250 ml of 1,2-dichlorobenzene and 18.7 g of 99% aluminum chloride powder was added to prepare for the Fries Rearrangement reaction. The solution was heated to 150° C. and held at that temperature for 1 h. The reaction solution was then cooled to room temperature and 150 ml of 2 N aqueous hydrochloric acid was added. The solution exhibited an exotherm to 70° C. It was transferred to a separatory funnel and the lower organic layer containing 4,6-di(meta-toluoyl)-2-methyl resorcinol was collected. The upper acid wash was discarded. The lower layer was re-introduced to the separatory funnel and washed in a similar fashion with 150 ml of 1 N aqueous hydrochloric acid and twice with 200 ml of reverse osmosis purified water. The dichlorobenzene solution was transferred to a 1 L round-bottom flask, which was charged with 500 ml of hexanes. The crystallization solution was cooled at 5° C. for 8 h and crystalline product was isolated by vacuum filtration. The light yellow crystals were washed with hexanes and air-dried to give 11.7 g of pure 4,6-di(meta-toluoyl)-2-methyl resorcinol.

### EXAMPLE 7

### Preparation of 2,4-dibenzoyl resorcinol

A 1 L 3-neck round-bottom flask that was fitted with a water-cooled reflux condenser, a magnetic stirrer and a nitrogen purge was charged with 250 ml of 1,2 dichlorobenzene and 59.0 g of benzoyl chloride. 56.3 g of 99% aluminum chloride powder was added to the reaction mixture which was stirred for 15 minutes. Next, 32.0 g of resorcinol was added gradually. The reaction solution exothermed to 50° C. and was stirred for 2 h to complete the esterification reaction. The reaction mixture was then heated to 165° C. for 1 h in order for the Fries rearrangement to take place.

For work-up, the reaction mixture was cooled to 60° C. and 400 ml of 2 N aqueous hydrochloric acid was added slowly. This mixture was stirred for 1 h to dissolve the aluminum complexes and was then transferred to a separatory funnel. 250 ml of 1,2 dichloroethane was added to help with dissolution of the product. The lower organic layer was collected and the upper acid wash was discarded. The organic layer was put back into the separatory funnel and washed in a similar fashion 2 times with 200 ml of 2 N aqueous hydrochloric acid and then 2 times with 200 ml of deionized water. The organic layer was concentrated to an oil with a vacuum distillation and the oil was then dissolved into 50 ml of ethyl acetate and 75 ml of hexanes. The crystallization solution was cooled at 5° C. for 6 days and finally the crystallized product was isolated with vacuum filtration. After washing with hexanes and air-drying, 15.4 g of the tan-colored crystalline 2,4-dibenzoyl resorcinol was obtained.

In an attempt to eliminate any ambiguity associated with the nomenclature of the compounds identified herein, structures of the same are provided herein below:

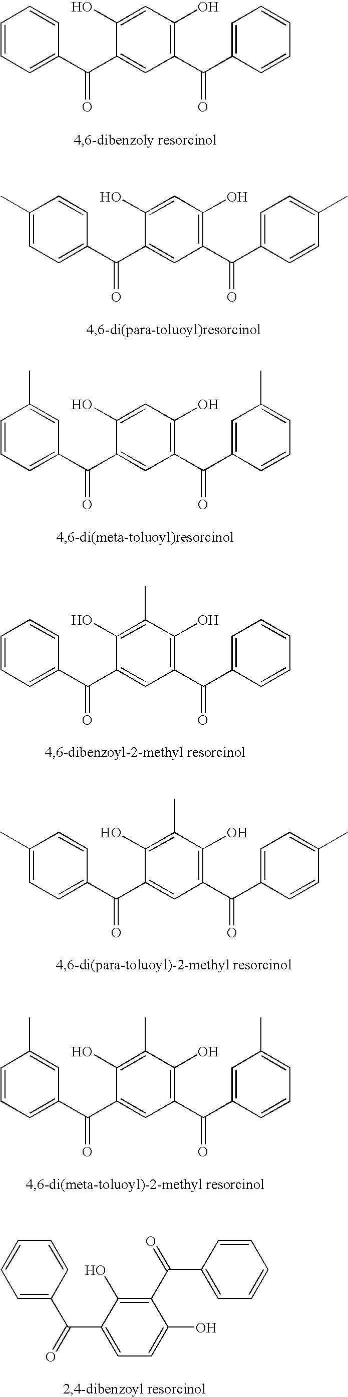

In support of the present invention, UV static and UV cycling experimentation was conducted wherein electrochromic devices were prepared which comprised prior art UV stabilizers (Tinuvin PE and Tinuvin 384), the color-stabilized performance of which was compared to analogous devices that additionally comprised 4,6-dibenzoyl resorcinol or 4,6-dibenzoyl-2-methyl resorcinol.

In discussing colors it is useful to refer to the Commission Internationale de l'Eclairage's (CIE) 1976 CIELAB Chromaticity Diagram (commonly referred to as the L*a*b* chart). The technology of color is relatively complex, but a fairly comprehensive discussion is given by F. W. Billmeyer and M. Saltzman in the Principles of Color Technology, 2^{nd} Ed., J. Wiley and Sons Inc. (1981), and the present disclosure, as it relates to color technology and terminology, generally follows that discussion. On the L*a*b* chart, L* defines lightness, a* denotes the red/green value, and b* denotes the yellow/blue value. Each of the electrochromic media has an absorption spectra at each particular voltage that may be converted into a three number designation, their L*a*b* values. For the present discussion, the a*, b*, ΔE, and ΔY values are relevant inasmuch as: (1) a medium with an increased a* value is more red; (2) a medium with a decreased a* value is more green; (3) a medium with an increased b* value is more yellow; (4) a medium with a decreased b* value is more blue; (5) a medium with an increased ΔE value has a greater overall color change; and (6) a medium with an increased ΔY value has a great overall change in lightness and/or intensity.

The Δa*, Δb*, ΔE, and ΔY values are calculated by importing L*a*b* values into the following formulae:

Δa*=(aₜ*−a₀*)
wherein: Subscript “0” is an initial value; and
   : Subscript “t” is a value after a given amount of time

Δb*=(bₜ*−b₀*)
wherein: Subscript “0” is an initial value; and
   : Subscript “t” is a value after a given amount of time

ΔE=SQRT((Lₜ*−L₀*)²+(aₜ*−a₀*)²+(bₜ*−b₀*)²)
wherein: SQRT is the square root operation;
   : Subscript “0” is an initial value (for L*, a*, and b*); and
   : Subscript “t” is a value after a given amount of time (for L*, a*, and b*)

ΔY=100×(((Lₜ*+16)/116)³−((L₀*+16)/116)³)
wherein: Subscript “0” is an initial value; and
   : Subscript “t” is a value after a given amount of time.

### Experiment No. 1 (UV Static)

In this experiment three electrochromic media were prepared by mixing the following materials together in the concentrations provided below:

| | | |
|---|---|---|
| Component | Material | Concentration |

Experiment No. 1A

| | | |
|---|---|---|
| Cathodic | 1,1′-dioctyl-4,4′-bipyridinium bis(tetrafluoroborate) | 27.0 mM |
| Anodic (1) | 5,10-dineopentyl-5,10-dihydrophenazine | 22.0 mM |
| Anodic (2) | 5,10-dineopentyl-2,7-[2(ethyl)butyl]-5,10- | 3.3 mM |
| | dihydrophenazine | |
| Redox Buffer (1) | 1,1′,2,2′,3,3′,4,4′,5,5′-decamethylferrocene | 0.5 mM |
| Redox Buffer (2) | 1,1′,2,2′,3,3′,4,4′,5,5′-decamethylferrocinium | 0.5 mM |
| | tetrafluoroborate | |
| Solvent | Propylene Carbonate (PC) | N/A |
| Prior Art UV (1) | Tinuvin PE | 30.0 mM |
| Stabilizer | | |
| Prior Art UV (2) | Tinuvin 384 | 15.0 mM |
| Stabilizer | | |
| Present Invention | None | — |
| UV Stabilizer | | |

Experiment No. 1B

| | | |
|---|---|---|
| Cathodic | 1,1′-dioctyl-4,4′-bipyridinium bis(tetrafluoroborate) | 27.0 mM |
| Anodic (1) | 5,10-dineopentyl-5,10-dihydrophenazine | 22.0 mM |
| Anodic (2) | 5,10-dineopentyl-2,7-[2(ethyl)butyl]-5,10- | 3.3 mM |
| | dihydrophenazine | |
| Redox Buffer (1) | 1,1′,2,2′,3,3′,4,4′,5,5′-decamethylferrocene | 0.5 mM |
| Redox Buffer (2) | 1,1′,2,2′,3,3′,4,4′,5,5′-decamethylferrocinium | 0.5 mM |
| | tetrafluoroborate | |
| Solvent | Propylene Carbonate (PC) | N/A |
| Prior Art UV (1) | Tinuvin PE | 30.0 mM |
| Stabilizer | | |
| Prior Art UV (2) | Tinuvin 384 | 15.0 mM |
| Stabilizer | | |
| Present Invention | 4,6-dibenzoyl resorcinol | 45.0 mM |
| UV Stabilizer | | |

Experiment No. 1C

| | | |
|---|---|---|
| Cathodic | 1,1′-dioctyl-4,4′-bipyridinium bis(tetrafluoroborate) | 27.0 mM |
| Anodic (1) | 5,10-dineopentyl-5,10-dihydrophenazine | 22.0 mM |
| Anodic (2) | 5,10-dineopentyl-2,7-[2(ethyl)butyl]-5,10- | 3.3 mM |
| | dihydrophenazine | |
| Redox Buffer (1) | 1,1′,2,2′,3,3′,4,4′,5,5′-decamethylferrocene | 0.5 mM |
| Redox Buffer (2) | 1,1′,2,2′,3,3′,4,4′,5,5′-decamethylferrocinium | 0.5 mM |
| | tetrafluoroborate | |
| Solvent | Propylene Carbonate (PC) | N/A |
| Prior Art UV (1) | Tinuvin PE | 30.0 mM |
| Stabilizer | | |
| Prior Art UV (2) | Tinuvin 384 | 15.0 mM |
| Stabilizer | | |
| Present Invention | 4,6-dibenzoyl-2-methyl resorcinol | 15.0 mM |
| UV Stabilizer | | |

Each of the media were associated with an electrochromic device for testing. Specifically, the device comprised two 2×5 inch substrates. The first substrate was coated with generally clear, conductive tin-doped indium oxide, and the second substrate was coated with tin-doped indium oxide as well. The substrates were spaced 250 microns apart for accommodating the medium.

As can be seen, Experiment No. 1A includes only prior art UV stabilizers and Experiment Nos. 1B and 1C include novel resorcinol UV stabilizers. In order to simulate a harsh UV environment, each of the above-prepared media were exposed to continuous UV radiation using a conventional, Atlas weatherometer. The media were then evaluated for their color stability by obtaining L*a*b* values at predetermined intervals. The L*a*b* data for Experiment Nos. 1A, 1B, and 1C are provided below.

### Experiment No. 1—UV Static

Experiment 1A

| Hours | Cycles | L* | A* | B* | Y | ΔE |
|---|---|---|---|---|---|---|
| 0.00 | 0 | 85.62 | −3.74 | 5.05 | 67.23 | 0.00 |
| 159.00 | 0 | 85.16 | −3.49 | 4.72 | 66.32 | 0.62 |
| 319.00 | 0 | 84.95 | −3.32 | 4.86 | 65.91 | 0.81 |
| 478.00 | 0 | 85.38 | −3.27 | 4.93 | 66.75 | 0.54 |
| 637.00 | 0 | 85.33 | −3.26 | 5.02 | 66.66 | 0.56 |
| 797.00 | 0 | 85.08 | −3.19 | 5.37 | 66.16 | 0.83 |
| 1123.00 | 0 | 85.08 | −3.18 | 5.78 | 66.16 | 1.07 |
| 1281.00 | 0 | 84.22 | −3.24 | 6.30 | 64.49 | 1.94 |
| 1442.00 | 0 | 84.38 | −3.14 | 6.39 | 64.80 | 1.92 |
| 1601.00 | 0 | 84.29 | −3.14 | 6.54 | 64.62 | 2.09 |
| 1740.00 | 0 | 83.62 | −3.05 | 6.88 | 63.34 | 2.80 |
| 1902.00 | 0 | 83.72 | −3.05 | 6.99 | 63.53 | 2.80 |
| 2042.00 | 0 | 84.12 | −3.07 | 6.98 | 64.30 | 2.53 |
| 2203.00 | 0 | 83.78 | −3.07 | 7.28 | 63.64 | 2.97 |
| 2347.00 | 0 | 83.65 | −3.02 | 7.43 | 63.40 | 3.17 |
| 2508.00 | 0 | 83.49 | −2.94 | 7.65 | 63.09 | 3.45 |
| 2835.00 | 0 | 82.97 | −2.84 | 8.17 | 62.11 | 4.19 |
| 2974.00 | 0 | 82.77 | −2.81 | 8.37 | 61.73 | 4.47 |
| 3133.00 | 0 | 82.64 | −2.72 | 8.60 | 61.49 | 4.75 |
| 3245.00 | 0 | 82.62 | −2.66 | 8.68 | 61.45 | 4.83 |
| 3573.00 | 0 | 81.94 | −2.47 | 9.25 | 60.19 | 5.73 |
| 3733.00 | 0 | 81.95 | −2.27 | 9.27 | 60.21 | 5.78 |
| 3845.00 | 0 | 82.05 | −2.31 | 9.37 | 60.39 | 5.78 |
| 4004.00 | 0 | 81.70 | −2.20 | 9.62 | 59.75 | 6.21 |
| 4165.00 | 0 | 81.44 | −2.05 | 9.93 | 59.27 | 6.64 |
| 4324.00 | 0 | 81.15 | −1.83 | 10.21 | 58.74 | 7.09 |
| 4510.00 | 0 | 79.87 | −1.56 | 10.69 | 56.45 | 8.34 |
| 4670.00 | 0 | 80.70 | −1.54 | 10.76 | 57.93 | 7.85 |
| 4808.00 | 0 | 80.22 | −1.32 | 11.18 | 57.07 | 8.52 |
| 4952.00 | 0 | 80.11 | −1.11 | 11.38 | 56.88 | 8.79 |
| 5113.00 | 0 | 79.60 | −0.80 | 11.87 | 55.98 | 9.56 |
| 5422.00 | 0 | 78.31 | −0.08 | 12.87 | 53.74 | 11.31 |
| 5566.00 | 0 | 77.44 | 0.43 | 13.55 | 52.27 | 12.51 |
| 5729.00 | 0 | 76.54 | 0.92 | 14.01 | 50.77 | 13.58 |
| 5889.00 | 0 | 75.45 | 1.42 | 14.66 | 49.00 | 14.91 |
| 6050.00 | 0 | 74.30 | 2.18 | 15.67 | 47.17 | 16.61 |
| 6211.00 | 0 | 73.43 | 2.74 | 16.49 | 45.82 | 17.93 |
| 6372.00 | 0 | 72.26 | 3.31 | 17.00 | 44.05 | 19.26 |
| 6531.00 | 0 | 71.01 | 4.55 | 18.30 | 42.20 | 21.39 |

Experiment 1B

| Hours | Cycles | L* | A* | B* | Y | ΔE |
|---|---|---|---|---|---|---|
| 0.00 | 0 | 85.91 | −4.06 | 5.86 | 67.81 | 0.00 |
| 237.00 | 0 | 85.42 | −3.71 | 5.73 | 66.83 | 0.62 |
| 376.00 | 0 | 85.20 | −3.64 | 5.99 | 66.40 | 0.84 |
| 536.00 | 0 | 84.84 | −3.50 | 6.15 | 65.69 | 1.24 |
| 697.00 | 0 | 84.72 | −3.45 | 6.31 | 65.46 | 1.41 |
| 856.00 | 0 | 84.64 | −3.35 | 6.36 | 65.30 | 1.54 |
| 1016.00 | 0 | 84.38 | −3.26 | 6.58 | 64.80 | 1.87 |
| 1175.00 | 0 | 84.82 | −3.19 | 6.68 | 65.65 | 1.62 |
| 1334.00 | 0 | 84.85 | −3.16 | 6.72 | 65.71 | 1.63 |
| 1494.00 | 0 | 84.61 | −3.11 | 7.00 | 65.25 | 1.97 |
| 1820.00 | 0 | 84.66 | −3.06 | 7.24 | 65.34 | 2.11 |
| 1978.00 | 0 | 83.95 | −3.06 | 7.61 | 63.97 | 2.81 |
| 2139.00 | 0 | 84.11 | −2.95 | 7.67 | 64.28 | 2.78 |
| 2298.00 | 0 | 84.15 | −2.90 | 7.74 | 64.35 | 2.82 |
| 2437.00 | 0 | 83.78 | −2.77 | 7.95 | 63.64 | 3.25 |
| 2599.00 | 0 | 83.62 | −2.75 | 8.08 | 63.34 | 3.45 |
| 2739.00 | 0 | 84.09 | −2.78 | 8.05 | 64.24 | 3.12 |
| 2900.00 | 0 | 83.81 | −2.75 | 8.20 | 63.70 | 3.41 |
| 3044.00 | 0 | 83.68 | −2.71 | 8.35 | 63.45 | 3.60 |
| 3205.00 | 0 | 83.62 | −2.65 | 8.43 | 63.34 | 3.72 |
| 3532.00 | 0 | 83.18 | −2.58 | 8.72 | 62.50 | 4.22 |
| 3671.00 | 0 | 83.27 | −2.55 | 8.77 | 62.67 | 4.21 |
| 3830.00 | 0 | 83.24 | −2.49 | 8.86 | 62.62 | 4.31 |
| 3942.00 | 0 | 83.20 | −2.47 | 8.97 | 62.54 | 4.42 |
| 4270.00 | 0 | 82.90 | −2.35 | 9.15 | 61.97 | 4.78 |
| 4430.00 | 0 | 82.94 | −2.27 | 9.16 | 62.05 | 4.79 |
| 4542.00 | 0 | 83.15 | −2.35 | 9.07 | 62.45 | 4.57 |
| 4701.00 | 0 | 83.01 | −2.31 | 9.13 | 62.18 | 4.71 |
| 4862.00 | 0 | 82.92 | −2.27 | 9.21 | 62.01 | 4.83 |
| 5021.00 | 0 | 82.84 | −2.18 | 9.29 | 61.86 | 4.97 |
| 5207.00 | 0 | 81.79 | −2.06 | 9.51 | 59.91 | 5.86 |
| 5367.00 | 0 | 82.94 | −2.23 | 9.43 | 62.05 | 4.99 |
| 5505.00 | 0 | 82.98 | −2.16 | 9.46 | 62.13 | 5.02 |
| 5649.00 | 0 | 83.03 | −2.13 | 9.51 | 62.22 | 5.03 |
| 5810.00 | 0 | 83.07 | −2.13 | 9.62 | 62.29 | 5.09 |
| 6119.00 | 0 | 82.90 | −2.03 | 9.75 | 61.97 | 5.32 |
| 6263.00 | 0 | 82.96 | −1.99 | 9.87 | 62.09 | 5.39 |
| 6425.00 | 0 | 82.65 | −1.88 | 9.74 | 61.51 | 5.52 |
| 6586.00 | 0 | 82.35 | −1.85 | 9.93 | 60.95 | 5.84 |
| 6747.00 | 0 | 82.08 | −1.68 | 9.82 | 60.45 | 6.00 |
| 6908.00 | 0 | 81.95 | −1.73 | 10.04 | 60.21 | 6.21 |

Experiment 1C

| Hours | Cycles | L* | A* | B* | Y | ΔE |
|---|---|---|---|---|---|---|
| 0.00 | 0 | 85.70 | −3.74 | 5.45 | 67.39 | 0.00 |
| 162.00 | 0 | 84.89 | −3.19 | 5.37 | 65.79 | 0.98 |
| 303.00 | 0 | 85.16 | −3.11 | 5.31 | 66.32 | 0.84 |
| 463.00 | 0 | 84.76 | −3.02 | 5.57 | 65.54 | 1.19 |
| 608.00 | 0 | 84.60 | −2.95 | 5.74 | 65.23 | 1.38 |
| 768.00 | 0 | 84.53 | −2.86 | 5.91 | 65.09 | 1.53 |
| 1095.00 | 0 | 83.94 | −2.77 | 6.47 | 63.95 | 2.25 |
| 1234.00 | 0 | 83.93 | −2.71 | 6.55 | 63.93 | 2.32 |
| 1393.00 | 0 | 83.70 | −2.65 | 6.82 | 63.49 | 2.66 |
| 1505.00 | 0 | 83.66 | −2.61 | 6.93 | 63.41 | 2.76 |
| 1833.00 | 0 | 83.33 | −2.48 | 7.28 | 62.79 | 3.25 |
| 1994.00 | 0 | 83.13 | −2.37 | 7.42 | 62.41 | 3.52 |
| 2105.00 | 0 | 83.40 | −2.45 | 7.39 | 62.92 | 3.27 |
| 2264.00 | 0 | 83.11 | −2.41 | 7.64 | 62.37 | 3.64 |
| 2425.00 | 0 | 82.96 | −2.37 | 7.84 | 62.09 | 3.89 |
| 2585.00 | 0 | 82.90 | −2.24 | 7.96 | 61.97 | 4.05 |
| 2770.00 | 0 | 81.81 | −2.10 | 8.38 | 59.95 | 5.14 |
| 2931.00 | 0 | 82.89 | −2.25 | 8.31 | 61.96 | 4.28 |
| 3069.00 | 0 | 82.67 | −2.17 | 8.47 | 61.54 | 4.56 |
| 3212.00 | 0 | 82.62 | −2.12 | 8.61 | 61.45 | 4.70 |
| 3374.00 | 0 | 82.82 | −2.07 | 8.71 | 61.82 | 4.66 |
| 3682.00 | 0 | 82.49 | −2.01 | 9.12 | 61.21 | 5.17 |
| 3827.00 | 0 | 82.33 | −1.92 | 9.34 | 60.91 | 5.46 |
| 3989.00 | 0 | 82.12 | −1.79 | 9.25 | 60.52 | 5.57 |
| 4149.00 | 0 | 81.76 | −1.75 | 9.49 | 59.86 | 5.98 |
| 4311.00 | 0 | 81.46 | −1.58 | 9.47 | 59.31 | 6.23 |
| 4471.00 | 0 | 81.22 | −1.58 | 9.76 | 58.87 | 6.58 |
| 4632.00 | 0 | 80.76 | −1.49 | 9.86 | 58.04 | 6.99 |
| 4791.00 | 0 | 80.81 | −1.41 | 10.13 | 58.13 | 7.16 |
| 4934.00 | 0 | 80.36 | −1.34 | 10.24 | 57.32 | 7.56 |
| 5120.00 | 0 | 80.21 | −1.20 | 10.49 | 57.05 | 7.87 |
| 5258.00 | 0 | 79.93 | −1.11 | 10.47 | 56.56 | 8.09 |
| 5363.00 | 0 | 79.88 | −1.06 | 10.54 | 56.47 | 8.18 |
| 5506.00 | 0 | 79.64 | −0.93 | 10.79 | 56.05 | 8.55 |
| 5667.00 | 0 | 79.87 | −0.88 | 10.91 | 56.45 | 8.48 |
| 5886.00 | 0 | 80.06 | −0.85 | 11.13 | 56.79 | 8.51 |
| 6021.00 | 0 | 79.96 | −0.74 | 11.32 | 56.61 | 8.74 |
| 6181.00 | 0 | 79.55 | −0.63 | 11.23 | 55.89 | 8.99 |
| 6342.00 | 0 | 79.76 | −0.58 | 11.49 | 56.26 | 9.04 |
| 6502.00 | 0 | 79.72 | −0.47 | 11.73 | 56.19 | 9.27 |
| 6661.00 | 0 | 79.82 | −0.44 | 11.88 | 56.36 | 9.32 |
| 6823.00 | 0 | 79.66 | −0.33 | 12.00 | 56.08 | 9.54 |
| 6985.00 | 0 | 79.53 | −0.25 | 12.08 | 55.85 | 9.71 |
| 7171.00 | 0 | 79.52 | −0.13 | 12.23 | 55.84 | 9.86 |
| 7306.00 | 0 | 79.82 | −0.19 | 12.28 | 56.36 | 9.69 |
| 7469.00 | 0 | 79.62 | −0.07 | 12.34 | 56.01 | 9.89 |
| 7629.00 | 0 | 79.67 | −0.20 | 12.79 | 56.10 | 10.14 |

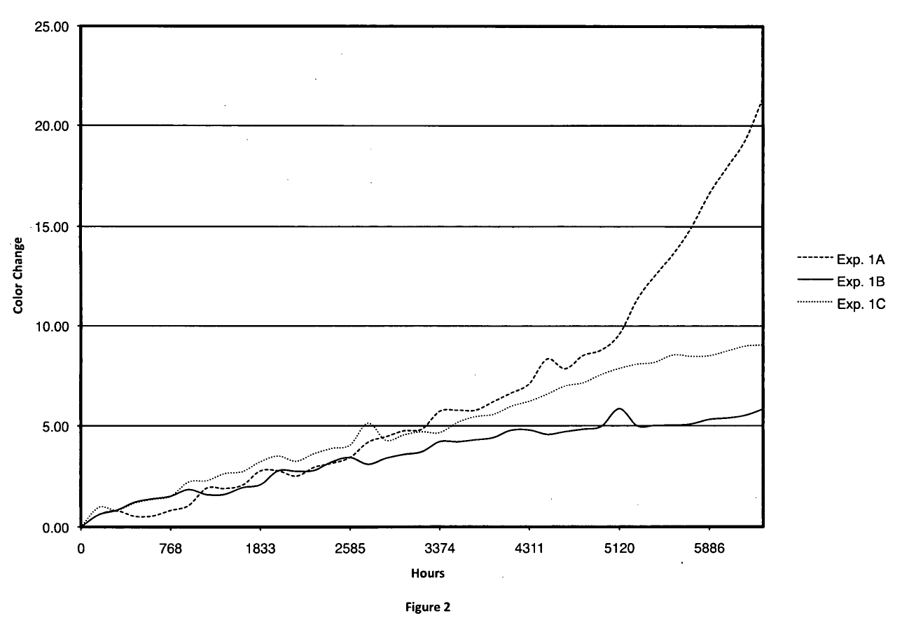

As can be seen from the data supra, the medium comprising only the prior art UV stabilizer (1A) turned substantially more yellow than the media which also comprised 4,6-dibenzoyl resorcinol (1B) and 4,6-dibenzoyl-2-methyl resorcinol (1C), as is evident by the increasingly positive b* value. The substantial difference in overall color change is best seen in FIG. 2 by the large ΔE value of experiment 1A relative to experiments 1B and 1C.

### Experiment No. 2 (UV Cycling)

In this experiment three electrochromic media were prepared by mixing the following materials together in the concentrations provided below:

| | | |
|---|---|---|
| Component | Material | Concentration |

Experiment No. 2A

| | | |
|---|---|---|
| Cathodic | 1,1′-dioctyl-4,4′-bipyridinium bis(tetrafluoroborate) | 27.0 mM |
| Anodic (1) | 5,10-dineopentyl-5,10-dihydrophenazine | 22.0 mM |
| Anodic (2) | 5,10-dineopentyl-2,7-[2(ethyl)butyl]-5,10- | 3.3 mM |
| | dihydrophenazine | |
| Redox Buffer (1) | 1,1′,2,2′,3,3′,4,4′,5,5′-decamethylferrocene | 0.5 mM |
| Redox Buffer (2) | 1,1′,2,2′,3,3′,4,4′,5,5′-decamethylferrocinium | 0.5 mM |
| | tetrafluoroborate | |
| Solvent | Propylene Carbonate (PC) | N/A |
| Prior Art UV (1) | Tinuvin PE | 30.0 mM |
| Stabilizer | | |
| Prior Art UV (2) | Tinuvin 384 | 15.0 mM |
| Stabilizer | | |
| Present Invention | None | — |
| UV Stabilizer | | |

Experiment No. 2B

| | | |
|---|---|---|
| Cathodic | 1,1′-dioctyl-4,4′-bipyridinium bis(tetrafluoroborate) | 27.0 mM |
| Anodic (1) | 5,10-dineopentyl-5,10-dihydrophenazine | 22.0 mM |
| Anodic (2) | 5,10-dineopentyl-2,7-[2(ethyl)butyl]-5,10- | 3.3 mM |
| | dihydrophenazine | |
| Redox Buffer (1) | 1,1′,2,2′,3,3′,4,4′,5,5′-decamethylferrocene | 0.5 mM |
| Redox Buffer (2) | 1,1′,2,2′,3,3′,4,4′,5,5′-decamethylferrocinium | 0.5 mM |
| | tetrafluoroborate | |
| Solvent | Propylene Carbonate (PC) | N/A |
| Prior Art UV (1) | Tinuvin PE | 30.0 mM |
| Stabilizer | | |
| Prior Art UV (2) | Tinuvin 384 | 15.0 mM |
| Stabilizer | | |
| Present Invention | 4,6-dibenzoyl resorcinol | 45.0 mM |
| UV Stabilizer | | |

Experiment No. 2C

| | | |
|---|---|---|
| Cathodic | 1,1′-dioctyl-4,4′-bipyridinium bis(tetrafluoroborate) | 27.0 mM |
| Anodic (1) | 5,10-dineopentyl-5,10-dihydrophenazine | 22.0 mM |
| Anodic (2) | 5,10-dineopentyl-2,7-[2(ethyl)butyl]-5,10- | 3.3 mM |
| | dihydrophenazine | |
| Redox Buffer (1) | 1,1′,2,2′,3,3′,4,4′,5,5′-decamethylferrocene | 0.5 mM |
| Redox Buffer (2) | 1,1′,2,2′,3,3′,4,4′,5,5′-decamethylferrocinium | 0.5 mM |
| | tetrafluoroborate | |
| Solvent | Propylene Carbonate (PC) | N/A |
| Prior Art UV (1) | Tinuvin PE | 30.0 mM |
| Stabilizer | | |
| Prior Art UV (2) | Tinuvin 384 | 15.0 mM |
| Stabilizer | | |
| Present Invention | 4,6-dibenzoyl-2-methyl resorcinol | 15.0 mM |
| UV Stabilizer | | |

Each of the media were associated with an electrochromic device for testing. Specifically, the device comprised two 2×5 inch substrates. The first substrate was coated with generally clear, conductive tin-doped indium oxide, and the second substrate was coated with tin-doped indium oxide as well. The substrates were spaced 250 microns apart for accommodating the medium.

As can be seen, Experiment No. 2A includes only prior art UV stabilizers and Experiment Nos. 2B and 2C include novel resorcinol UV stabilizers. In order to simulate a harsh UV environment, each of the above-prepared media were exposed to cyclic UV radiation using a conventional, Atlas weatherometer (the cyclic profile consisted of 2 minutes on and 2 minutes off at 0.55 Irr). The media were then evaluated for their color stability by obtaining L*a*b* values at predetermined intervals. The L*a*b* data for Experiment Nos. 2A, 2B, and 2C are provided below.

### Experiment No. 2—UV Cycling

Experiment 2A

| Hours | Cycles | L* | A* | B* | Y | ΔE |
|---|---|---|---|---|---|---|
| 0.00 | 0 | 85.28 | −3.70 | 4.83 | 66.56 | 0.00 |
| 160.00 | 2417 | 84.43 | −3.50 | 4.46 | 64.90 | 0.95 |
| 319.00 | 4804 | 84.42 | −3.55 | 4.43 | 64.88 | 0.96 |
| 478.00 | 7230 | 84.25 | −3.78 | 4.59 | 64.55 | 1.06 |
| 638.00 | 9620 | 83.61 | −3.81 | 4.85 | 63.32 | 1.67 |
| 919.00 | 13845 | 82.77 | −3.86 | 5.29 | 61.73 | 2.56 |
| 1077.00 | 16219 | 82.05 | −4.09 | 5.82 | 60.39 | 3.40 |
| 1238.00 | 18612 | 81.54 | −4.11 | 6.04 | 59.45 | 3.95 |
| 1397.00 | 21009 | 81.21 | −4.12 | 6.40 | 58.85 | 4.38 |
| 1536.00 | 23077 | 80.37 | −4.03 | 6.86 | 57.34 | 5.32 |
| 1698.00 | 25507 | 79.64 | −3.99 | 7.43 | 56.05 | 6.22 |
| 1838.00 | 27609 | 79.55 | −3.97 | 7.70 | 55.89 | 6.41 |
| 1999.00 | 30017 | 78.88 | −3.91 | 8.36 | 54.72 | 7.31 |
| 2143.00 | 32178 | 78.35 | −3.79 | 8.95 | 53.81 | 8.06 |
| 2303.00 | 34578 | 76.98 | −3.13 | 10.85 | 51.50 | 10.27 |
| 2631.00 | 39479 | 75.12 | −2.72 | 12.42 | 48.47 | 12.72 |
| 2770.00 | 41561 | 74.46 | −2.52 | 13.01 | 47.42 | 13.62 |
| 2929.00 | 43945 | 73.43 | −2.69 | 12.26 | 45.82 | 14.02 |
| 3041.00 | 45976 | 73.37 | −1.98 | 14.49 | 45.73 | 15.43 |
| 3369.00 | 50884 | 71.43 | −1.36 | 16.13 | 42.82 | 18.03 |
| 3529.00 | 53288 | 70.68 | −0.91 | 16.71 | 41.72 | 19.03 |
| 3641.00 | 54942 | 70.46 | −0.77 | 17.34 | 41.41 | 19.61 |
| 3800.00 | 57327 | 69.51 | −0.29 | 18.09 | 40.06 | 20.88 |

Experiment 2B

| Hours | Cycles | L* | A* | B* | Y | ΔE |
|---|---|---|---|---|---|---|
| 0.00 | 0 | 85.62 | −3.93 | 5.76 | 67.23 | 0.00 |
| 327.00 | 4991 | 84.72 | −3.68 | 5.71 | 65.46 | 0.94 |
| 450.00 | 7023 | 84.28 | −3.70 | 5.98 | 64.61 | 1.38 |
| 609.00 | 9437 | 84.09 | −3.76 | 6.16 | 64.24 | 1.59 |
| 937.00 | 14409 | 83.73 | −3.82 | 6.45 | 63.55 | 2.02 |
| 1074.00 | 16501 | 83.84 | −3.79 | 6.36 | 63.76 | 1.88 |
| 1235.00 | 18929 | 84.12 | −3.86 | 6.53 | 64.30 | 1.69 |
| 1394.00 | 21353 | 83.77 | −3.84 | 6.72 | 63.62 | 2.09 |
| 1553.00 | 23772 | 83.64 | −3.92 | 7.08 | 63.38 | 2.38 |
| 1864.00 | 28523 | 83.26 | −3.94 | 7.33 | 62.65 | 2.83 |
| 2005.00 | 30939 | 82.80 | −4.01 | 7.74 | 61.79 | 3.45 |
| 2148.00 | 33107 | 82.76 | −4.00 | 7.85 | 61.71 | 3.54 |
| 2286.00 | 35234 | 82.17 | −3.96 | 8.25 | 60.61 | 4.25 |
| 2445.00 | 37651 | 82.02 | −3.98 | 8.46 | 60.34 | 4.50 |
| 2606.00 | 40094 | 82.13 | −4.06 | 8.55 | 60.54 | 4.47 |
| 2767.00 | 42532 | 81.87 | −4.05 | 8.81 | 60.06 | 4.84 |
| 2929.00 | 45052 | 81.59 | −4.02 | 8.96 | 59.54 | 5.15 |
| 3068.00 | 47222 | 81.35 | −4.11 | 9.30 | 59.11 | 5.55 |
| 3230.00 | 49689 | 80.97 | −4.02 | 9.70 | 58.42 | 6.10 |
| 3558.00 | 54670 | 80.64 | −4.10 | 10.20 | 57.82 | 6.67 |
| 3700.00 | 56874 | 80.48 | −4.07 | 10.26 | 57.54 | 6.83 |
| 3862.00 | 59430 | 80.24 | −4.06 | 10.51 | 57.11 | 7.18 |

Experiment 2C

| Hours | Cycles | L* | A* | B* | Y | ΔE |
|---|---|---|---|---|---|---|
| 0.00 | 0 | 84.89 | −3.64 | 5.23 | 65.79 | 0.00 |
| 162.00 | 2430 | 84.13 | −3.38 | 5.14 | 64.32 | 0.81 |
| 303.00 | 4532 | 84.05 | −3.64 | 4.94 | 64.16 | 0.89 |
| 463.00 | 6940 | 83.46 | −3.81 | 5.01 | 63.03 | 1.46 |
| 608.00 | 9101 | 82.94 | −3.97 | 4.99 | 62.05 | 1.99 |
| 768.00 | 11501 | 82.45 | −4.17 | 5.08 | 61.13 | 2.50 |
| 1095.00 | 16402 | 81.38 | −4.59 | 5.19 | 59.16 | 3.64 |
| 1234.00 | 18484 | 81.03 | −4.73 | 5.26 | 58.53 | 4.01 |
| 1393.00 | 20868 | 80.68 | −4.90 | 5.32 | 57.89 | 4.40 |
| 1505.00 | 22899 | 80.57 | −5.02 | 5.35 | 57.70 | 4.54 |
| 1833.00 | 27807 | 79.22 | −5.61 | 4.91 | 55.31 | 6.01 |
| 1994.00 | 30211 | 77.96 | −6.22 | 3.63 | 53.14 | 7.57 |
| 2105.00 | 31865 | 78.09 | −6.42 | 3.59 | 53.36 | 7.53 |
| 2264.00 | 34250 | 77.53 | −6.61 | 3.57 | 52.42 | 8.11 |
| 2425.00 | 36670 | 77.30 | −6.56 | 4.11 | 52.03 | 8.21 |
| 2585.00 | 39060 | 76.89 | −6.73 | 4.00 | 51.35 | 8.66 |
| 2770.00 | 41840 | 75.92 | −6.60 | 4.63 | 49.76 | 9.46 |
| 2931.00 | 41881 | 77.64 | −6.27 | 5.90 | 52.60 | 7.74 |
| 3069.00 | 43948 | 77.29 | −6.15 | 6.37 | 52.02 | 8.08 |
| 3212.00 | 46101 | 77.15 | −6.23 | 6.48 | 51.78 | 8.26 |
| 3374.00 | 48518 | 77.00 | −6.42 | 6.58 | 51.53 | 8.47 |
| 3682.00 | 53141 | 76.41 | −6.55 | 6.92 | 50.56 | 9.12 |
| 3827.00 | 55298 | 76.16 | −6.45 | 7.10 | 50.15 | 9.36 |

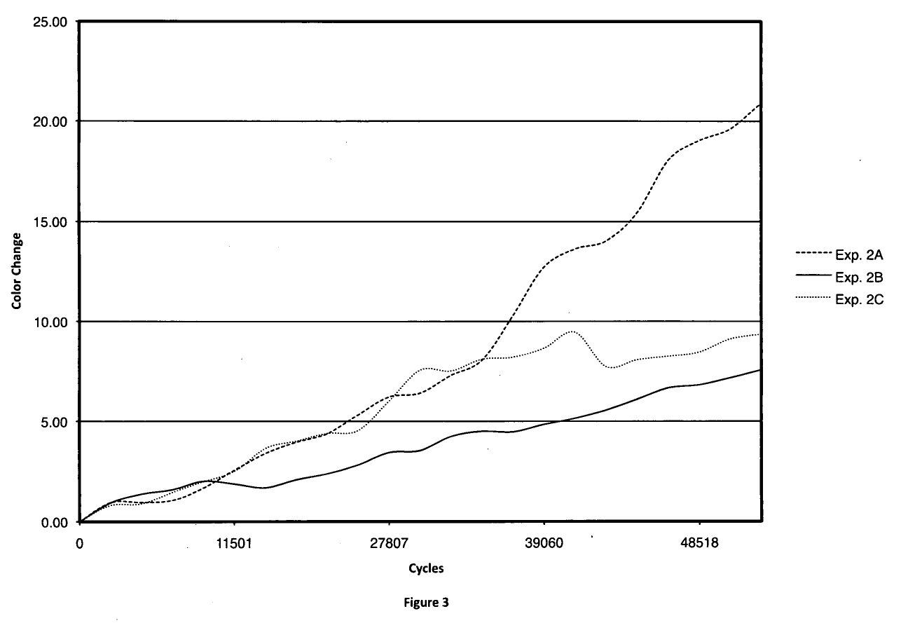

As can be seen from the data supra, the medium comprising only the prior art UV stabilizer (2A) turned substantially more yellow than the media which also comprised 4,6-dibenzoyl resorcinol (2B) and 4,6-dibenzoyl-2-methyl resorcinol (2C), as is evident by the increasingly positive b* value. The substantial difference in overall color change is best seen in FIG. 3 by the large ΔE value of experiment 2A relative to experiments 2B and 2C.

While the invention has been described in detail herein in accordance with certain preferred embodiments thereof, many modifications and changes therein may be effected by those skilled in the art. Accordingly, it is our intent to be limited only by the scope of the appending claims and not by way of details and instrumentalities describing the embodiments shown herein.

1. (canceled)

2. An electrochromic medium for use in an electrochromic device, comprising:
at least one solvent;
at least one anodic electroactive material;
at least one cathodic electroactive material;
wherein at least one of the anodic and cathodic electroactive materials is electrochromic; and
an ultraviolet light stabilizing compound selected from the group consisting of formulae I, II, III, IV, V, VI and combinations thereof; wherein formula I is: 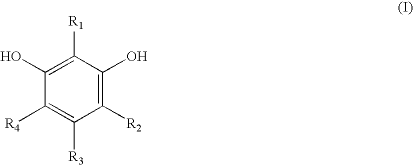
wherein R₁-R₄ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 50 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer: a linkage to an oligomer; and/or a linkage to a polymer; with the proviso that at least two of R₁-R₄ are the same or different and comprise an aroyl group containing approximately 6 to approximately 25 carbon atom(s); wherein formula II is: 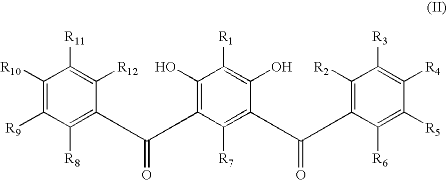
wherein R₁-R₁₂ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer;
wherein formula III is: 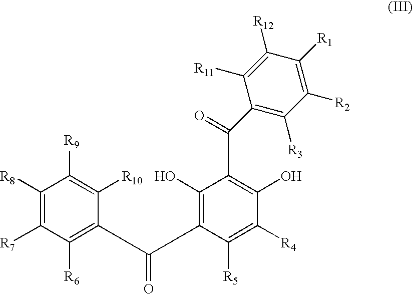
wherein R₁-R₁₂ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s). wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer;
wherein formula IV is: 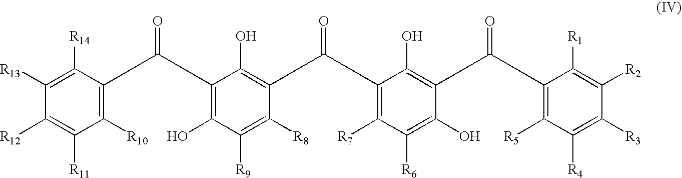
wherein R₁-R₁₄ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer;
wherein formula V is: 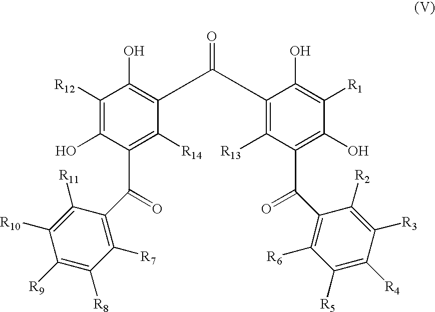
wherein R₁-R₁₄ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer; and
wherein formula VI is: 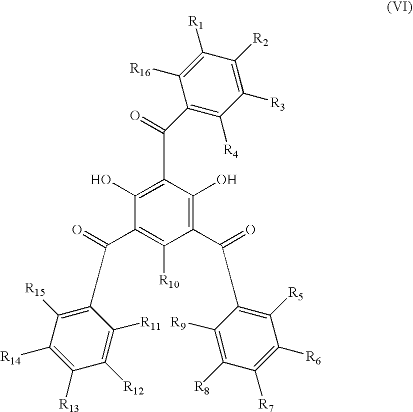
wherein R₁-R₁₆ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer.

3. (canceled)

4. The electrochromic medium according to claim 2, wherein the ultraviolet light stabilizing compound is represented by the following formula: 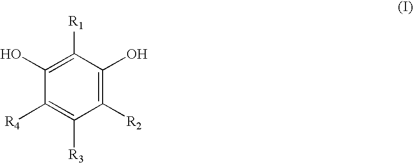
wherein R₁-R₄ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 50 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer; with the proviso that at least two of R₁-R₄ are the same or different and comprise an aroyl group containing approximately 6 to approximately 25 carbon atom(s).

5. The electrochromic medium according to claim 4, wherein the ultraviolet light stabilizing compound is represented by the following formula: 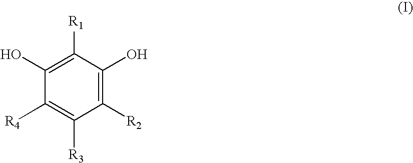
wherein R1 comprises H; an alkyl, alkoxy, and/or cyano group containing approximately 1 to approximately 50 carbon atom(s); a linkage to a dimer; a linkage to an oligomer; and/or a linkage to a polymer;
wherein R₃ comprises H; and
wherein R₂ and R₄ are the same or different and comprise a substituted or unsubstituted benzoyl group containing approximately 6 to approximately 25 carbon atoms.

6. The electrochromic medium according to claim 2, wherein the ultraviolet light stabilizing compound is represented by the following formula: 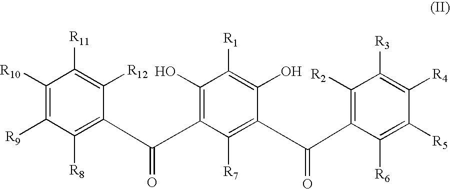
wherein R₁-R₁₂ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer.

7. The electrochromic medium according to claim 2, wherein the ultraviolet light stabilizing compound is represented by the following formula: 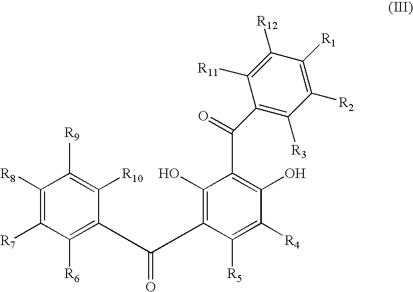
wherein R₁-R₁₂ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer.

8. The electrochromic medium according to claim 2, wherein the ultraviolet light stabilizing compound is represented by the following formula: 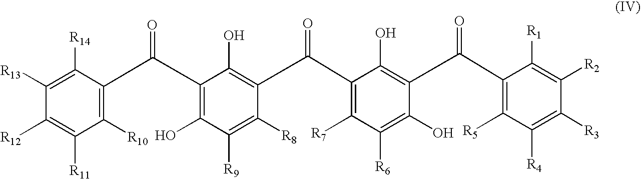
wherein R₁-R₁₄ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer.

9. The electrochromic medium according to claim 2, wherein the ultraviolet light stabilizing compound is represented by the following formula: 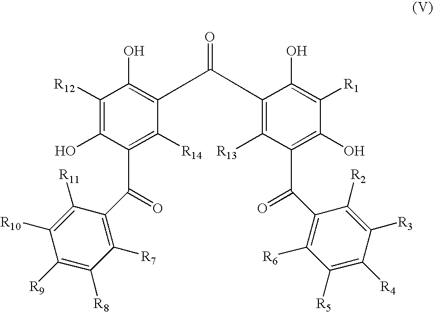
wherein R₁-R₁₄ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer.

10. The electrochromic medium according to claim 2, wherein the ultraviolet light stabilizing compound is represented by the following formula: 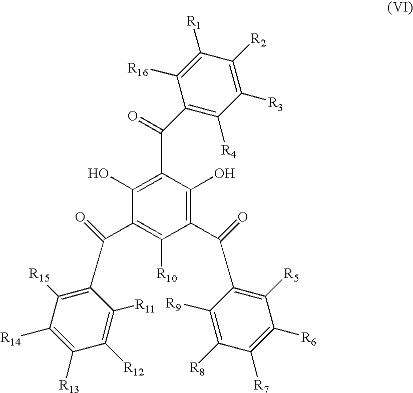
wherein R₁-R₁₆ are the same or different and comprise H; OH; an alkyl, cycloalkyl, polycycloalkyl, heterocycloalkyl, aryl, alkaryl, aralkyl, alkoxy, alkoyl, aroyl, alkenyl, alkynyl and/or cyano group containing approximately 1 to approximately 25 carbon atom(s), wherein the carbon atom(s) may be a linking group to, or part of, a halogen, a N, O, and/or S containing moiety, and/or one or more functional groups comprising alcohols, esters, ammonium salts, phosphonium salts, and combinations thereof; a linkage to a dimer; a linkage to an oligomer; and/or a linkage to a polymer.

11. The electrochromic medium according to claim 2, wherein the electrochromic medium further comprises at least one of a cross-linked polymer matrix, a free-standing gel, and a substantially non-weeping gel.

12. An electrochromic device, comprising:
at least one substrate having an electrically conductive material associated therewith; and
the electrochromic medium according to claim 2.

13. The electrochromic device according to claim 12, wherein the device comprises an electrochromic window.

14. The electrochromic device according to claim 12, wherein a substrate is coated with a reflective material.

15. The electrochromic device according to claim 14, wherein the device comprises an electrochromic mirror.

16. The electrochromic device according to claim 15, wherein the device comprises a metallic ring around a perimeter.

17. The electrochromic device according to claim 12, wherein a substrate is less than approximately 1.0 mm thick.

18. The electrochromic device according to claim 17, wherein the device is an aircraft transparency.

19. The electrochromic device according to claim 12, wherein a substrate comprises a hydrophilic coating.

20. An electrochromic device, comprising:
a first substantially transparent substrate having an electrically conductive material associated therewith;
a second substrate having an electrically conductive material associated therewith; and
an electrochromic medium according to claim 2 contained within a chamber positioned between the first and second substrates.
